(19) United States
(12) Patent Application Publication
(10) Pub. No.: US 2023/0416868 A1
(43) Pub. Date: Dec. 28, 2023

(54) Method for treating molten metals and/or slags in metallurgical baths and metallurgical plant for treating molten metals

(71) Applicant: SMS group GmbH, Düsseldorf (DE)

(72) Inventors: Hans-Jürgen ODENTHAL, Mettmann (DE); Andreas KEMMINGER, Düsseldorf (DE); Stephan GEIMER, Mühlheim (DE)

(73) Assignee: SMS group GmbH, Düsseldorf (DE)

(21) Appl. No.: 18/037,991

(22) PCT Filed: Sep. 7, 2021
(86) PCT No.: PCT/EP2021/074560

§ 371 Date: May 19, 2023

(30) Foreign Application Priority Data
Nov. 30, 2020 (DE) 10 2020 215 076.1

(51) Int. Cl. C22B 9/05; C21C 5/34; C21C 5/46; C21C 7/072; F27D 3/16; F27B 3/22

(52) U.S. Cl. CPC C22B 9/05; C21C 5/34; C21C 5/4606; C21C 7/072; F27D 3/16; F27B 3/225; F27D 2003/164

(57) ABSTRACT

A method for treating molten metals (4) and/or slags in metallurgical baths comprises the introduction of a process gas into a melt bath. The process gas is accelerated to supersonic speed and is introduced below the melt bath surface (5) by means of at least one supersonic nozzle (6) with supersonic speed into the liquid phase of the molten metal (4) and/or into the slag and/or into the region of a phase boundary between molten metal and slag. The disclosure further relates to a metallurgical plant for treating molten metals.

### CROSS-REFERENCE TO RELATED APPLICATION

This application is a national stage application, filed under 35 U.S.C. § 371, of International Patent Application PCT/EP2021/074560 filed on Sep. 7, 2021, which claims the benefit of German Patent Application DE 10 2020 215 076.1 filed on Nov. 30, 2020.

### TECHNICAL FIELD

The disclosure relates to a method for treating molten metals and/or slags in metallurgical baths, comprising the introduction of a process gas into a melt bath. The disclosure further relates to a metallurgical plant for treating molten metals having a melting vessel and means for gassing a molten metal and/or a slag.

### BACKGROUND

In metallurgical plants, process gases such as air, oxygen, nitrogen, argon, hydrocarbons, hydrogen, etc. are used to treat molten metals. For example, treatment with such process gases is to oxidize undesirable accompanying elements in the molten metal or to reduce metals and/or slags.

With the pyrometallurgical treatment of metals and molten metals in electric arc furnaces, the blowing/injection of oxygen-rich gases and/or carbon-containing particles into and/or onto a slag/foam slag layer is known. From EP 1 466 022 B 1 for example, a method is known for the pyrometallurgical treatment of metals, molten metals and/or slags, with which oxygen-containing gases are accelerated to supersonic speed with the aid of an injection device, wherein the high-speed jet exiting the injection device is used for the pyrometallurgical treatment of the molten metal. The high-speed jet is protected by a gaseous jacket of hot gas enveloping it, which is fed to the high-speed jet in such a manner as to minimize the relative speed and momentum exchange between the central high-speed jet and the hot-gas jacket jet. This method of surrounding the central oxygen-rich gas jet with a hot gas with the lowest possible momentum loss maximizes the length and penetration depth of the gas jet into the slag layer above the molten metal to generate intensive mixing and agitation of the slag layer. Thereby, with the method described in EP 1 466 022 B 1, the gas jet is blown from above onto the slag and into the boundary layer between the slag and the metal.

From WO 2019/158479 A1 a method for treating a molten metal in a converter is known, with which pure oxygen is applied from above to the surface of the melt bath at high pressure and at supersonic speed by means of a water-cooled lance, forming a cavity in the slag.

The use of supersonic injectors in the connection described above is known from various publications, for example EP 0 964 065 A 1.

It is also known in the prior art to introduce process gases into the molten metal below the surface of the melt bath, so that the process gases can react there directly with the liquid metal or slag. The introduction of such gases can be done, for example, by so-called “bottom flushers” or “side wall flushers.” Such lower bath gas treatment involves the introduction of the process gas in the form of bubbles or in the form of closed gas jets that enter the liquid phase of the melt. Injection of gas jets occurs in lower bath gas treatment at speeds below the speed of sound. In many applications, there are undesirable side effects in the region where the process gases enter the molten metal, such as the clogging of the flusher. In addition, the refractory material of the melting vessel above the gas inlet is subject to increased wear.

### SUMMARY

In principle, a high penetration depth of the process gas into the molten metal along with the generation of a stirring effect by the gas entry within the molten metal are desirable.

Therefore, the disclosure is based on the object of providing a method of the type mentioned in the background that avoids the disadvantages mentioned above.

The object underlying the invention is achieved by a method for treating molten metals and/or slags in metallurgical baths as disclosed herein, and by the provision of a metallurgical plant as disclosed herein. Advantageous embodiments of the invention are covered by the claims.

One aspect of the disclosure relates to a method for treating molten metals and/or slags in metallurgical baths, comprising the introduction of a process gas into a melt bath, wherein the process gas is accelerated to supersonic speed and is introduced below the melt bath surface by means of at least one supersonic nozzle at supersonic speed into the liquid phase of the molten metal and/or into the slag and/or into the region of a phase boundary between molten metal and slag.

The term “melt bath” as used in the present application comprises both the molten metal and the slag droplets suspended in the molten metal, along with the slag on the molten metal.

The procedure in accordance with the disclosure has the particular advantage that by accelerating the process gas to supersonic speed, the exit momentum of the process gas into the liquid phase of the molten metal is significantly increased, resulting in a higher penetration depth of the process gas or the supersonic gas jet into the molten metal. With a higher exit momentum of the process gas into the molten metal, increased wear of the refractory material of a metallurgical vessel receiving the molten metal is also avoided. The higher exit momentum shifts the region where individual gas bubbles break off from the gas jet entering the molten metal further away from the vessel wall. The associated recoil of the gas jet against the vessel wall (back attack) is reduced, thus reducing the wear of the refractory material. The introduction of the process gas or gases at supersonic speed generates turbulence in the molten metal and consequently a stirring effect in the molten metal. The higher momentum of the process gas as it enters the molten metal or slag makes it more difficult for the molten metal or slag to run back. This reduces the risk of clogging at the supersonic nozzle used. High shear forces between the process gases and the molten metal further lead to greater disintegration of primary bubbles and smaller bubble sizes, increasing the total surface area of the gas bubbles. This in turn leads to a higher output of the process gas.

The process gas is expediently a gas selected from a group comprising air, oxygen, nitrogen, argon, hydrocarbons (CₓH_{y}) and hydrogen.

With a preferred variant of the method, it is provided that the process gas is introduced at several locations of the melt bath using a plurality of supersonic nozzles.

The process gas can be introduced into the molten metal at different heights relative to the melt bath surface.

In an advantageous variant of the method, it is provided that at least one supersonic nozzle is designed as a Laval supersonic nozzle with a convergent nozzle part and a divergent nozzle part. In the convergent part of the nozzle, the diameter is steadily tapered, wherein the gas speed increases and the pressure decreases until the speed of sound is reached in the narrowest cross-section (Mach number equal to 1). In the divergent part of the nozzle, its diameter increases steadily, wherein the process gas is further accelerated and the pressure is further reduced. This causes the gas to accelerate beyond the local speed of sound.

Both the convergent section of the supersonic nozzle and the divergent section of the supersonic nozzle may have a bell-shaped contour, wherein the bell-shaped contours of the convergent section and the divergent section of the supersonic nozzle merge continuously into one another in a nozzle throat. Such a geometry or contour ensures that the nozzle can be used without malfunctions and with low wear, and that the jet momentum at the nozzle outlet is at a maximum, such that a large supersonic length of the gas jet is realized.

In principle, a supersonic nozzle can only be designed for one operating point with regard to the upstream pressure of the process gas, the volume flow and the ambient pressure within the molten metal. Preferably, such gas-dynamic design point of the supersonic nozzle is selected such that the gas pressure of the process gas at an outlet cross-section of the supersonic nozzle corresponds to the ambient pressure within the molten metal. If the gas pressure of the process gas at an inlet cross-section of the supersonic nozzle is adjusted such that the gas pressure of the process gas at the outlet cross-section of the supersonic nozzle corresponds to the ambient pressure within the molten metal, the supersonic nozzle is operated at the design point.

The supersonic nozzle is preferably designed according to isentropic filament theory or with the aid of a characteristic method. The objective of the design for the method is to make the exit area of the supersonic nozzle similar in size to the exit area of the subsonic nozzles used in the prior art. With the same outlet cross-section, a correspondingly designed supersonic nozzle generates a higher outlet momentum force. This force results from:

F_{exit momentum}=ρu²A[N],

wherein ρ is the gas density at the nozzle outlet, u is the gas speed at the nozzle outlet and A is the outlet diameter of the supersonic nozzle.

The characteristic method is a mathematical method for solving the partial gas dynamic differential equation for stationary isentropic, rotationally symmetric gas flows given below:

$$( {u}^{2} - {a}^{2} ) \frac{\partial u}{\partial x} + ( {v}^{2} - {a}^{2} ) \frac{\partial v}{\partial r} + uv ( \frac{\partial u}{\partial r} + \frac{\partial v}{\partial x} ) = 0$$

u,v: Flow speed in axial and radial direction
x,r: Axial and radial coordinate
a: Speed of sound

Mach lines, that is, lines of weak pressure perturbations propagating at the speed of sound and arranged at a certain angle to the local speed vector, are taken as the basis for the so-called “right-handed” and “left-handed” characteristics. Along these characteristic lines (characteristics), the analytical solution of the above differential equation is possible and therefore known.

A characteristic method suitable for the design of the supersonic nozzle for use in the method is disclosed, for example, in EP 2 553 127 Bl.

With one variant of the method, it can be provided that at least one supersonic nozzle is operated outside a gas-dynamic design point. For example, it can be provided to operate the supersonic nozzle in such a manner that the process gas under-expands or over-expands in the molten metal, resulting in the occurrence of oblique or vertical compression shocks along with expansion waves in the molten metal. This can generate a pumping motion in the molten metal. Over-expansion of the process gas occurs if the process gas is fed to the supersonic nozzle at a lower pressure (upstream pressure) than the upstream pressure in accordance with the design. Under-expansion of the process gas occurs if the upstream pressure of the process gas at an inlet cross-section of the supersonic nozzle is fed at a pressure greater than the upstream pressure in accordance with the design. With both the one and the other mode of operation, complex disturbance patterns (diamond patterns) are formed in the molten metal in the form of expansion waves and compression shocks, which the method utilizes to achieve a stirring effect within the molten metal.

With a further advantageous variant of the method, it can be provided that at least one supersonic nozzle is subjected to changing volume flows and/or pressures of the process gas during operation, such that such pulsating mode of the supersonic nozzle generates an advantageous pumping effect and thus intensive mixing within the molten metal.

If multiple supersonic nozzles are arranged at different locations and at different heights with respect to the melt bath surface on or in a metallurgical vessel, they can, for example, each be designed for different operating points, that is, have different diameters.

Individual supersonic nozzles of a metallurgical vessel can be individually controlled and thereby subjected to changing volume flows and/or pressures. In this manner, the method can accommodate different geometries of different metallurgical vessels.

The process gas can be introduced into a metallurgical vessel vertically from below and/or laterally at various angles.

The process gas can be introduced either directly into the liquid phase of the molten metal and/or slag or alternatively or additionally in the region of a phase boundary between the molten metal and the slag. In any event, a substantial feature of the method is that the process gas is introduced into the lower bath.

The method comprises the use of a metallurgical vessel, for example in the form of a converter, ladle, electric arc furnace or the like, having a plurality of supersonic nozzles passing through a wall and/or a bottom of the vessel.

A Pierce Smith converter, for example, can be used as a metallurgical vessel. Such a converter comprises a rotatable cylinder for receiving the molten metal. By rotating the cylinder, the supersonic nozzles can be positioned such that, for example, the process gas can be introduced in the region of the phase boundary between the slag and the melt. This achieves an intensification of the gas treatment.

A further aspect relates to a metallurgical plant for treating molten metals with a metallurgical vessel, with means for gassing a molten metal and/or a slag, characterized in that the means for gassing the molten metal comprise at least one supersonic nozzle in a bottom and/or in a wall of the metallurgical vessel, which nozzle is arranged with respect to a melt bath surface in such a manner that a lower bath introduction of the process gas can be carried out into the molten metal.

Expediently, multiple supersonic nozzles are arranged in at least one replaceable cassette of the melting vessel. The cassette can have a nozzle array with a plurality of supersonic nozzles arranged in a predetermined pattern. In this manner, multiple supersonic nozzles may be installed and removed quickly and easily. The arrangement of the supersonic nozzles in one or more cassettes and the number of cassettes depends on the type of application.

With an advantageous variant of the system, a plurality of nozzles in a cassette can be designed for a different volume flow of the process gas to be fed to the molten metal.

The invention is explained below with reference to the accompanying figures.

### BRIEF DESCRIPTION OF THE DRAWINGS

FIG. 1 is a schematic illustration of the arrangement of a supersonic nozzle in a side wall of a metallurgical vessel.

FIG. 2 is a schematic illustration of a metallurgical vessel designed as a Pierce Smith converter.

FIG. 3 is an illustration showing the speed profile of the process gas exiting from a supersonic nozzle operated at the design point.

FIG. 4 is an image corresponding to FIG. 2, wherein the wave patterns generated by the exiting process gas within the molten metal during the over-expanding mode of the supersonic nozzle are shown.

FIG. 5 is an image corresponding to FIG. 2, wherein the wave patterns generated by the exiting process gas within the molten metal during the under-expanding mode of the supersonic nozzle are shown.

### DETAILED DESCRIPTION

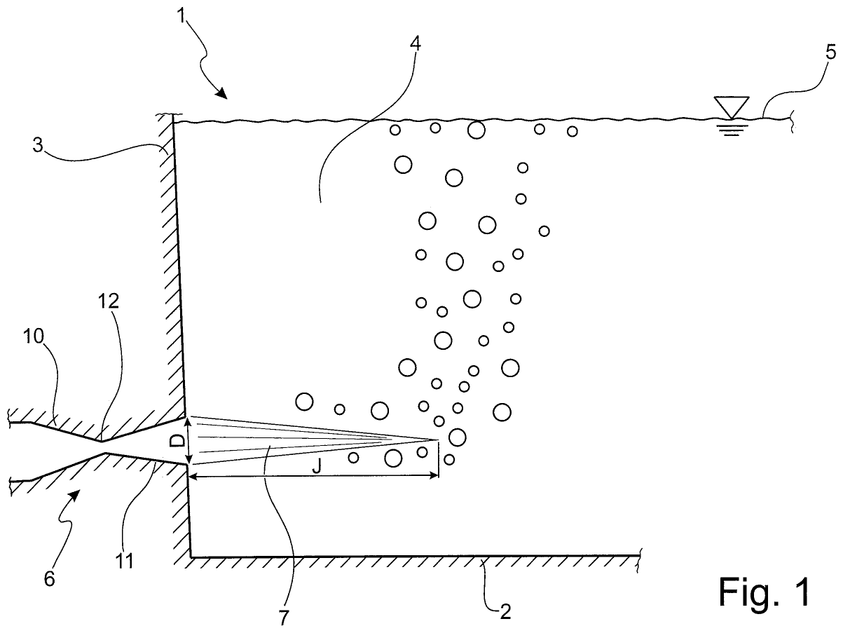

FIG. 1 shows a metallurgical vessel 1 of a plant for treating molten metals, comprising a bottom 2 and a side wall 3, which are lined with a refractory material. The metallurgical vessel 1 is filled with a molten metal 4 into which a process gas, for example in the form of pure oxygen, is introduced below a melt bath surface 5 in the lower bath. For this purpose, a supersonic nozzle 6 with a certain outlet diameter D is provided in the side wall 3 of the metallurgical vessel 1. The metallurgical vessel 1 is shown only in simplified form for illustrative purposes. This can comprise a plurality of supersonic nozzles 6 recessed at different locations in the side wall 3 or bottom 2 of the metallurgical vessel 1 (side wall flusher and/or bottom flusher). The gas jet 7 introduced by the supersonic nozzle 6 into the metallurgical vessel 1 exits the supersonic nozzle 6 at a gas pressure corresponding to the ambient pressure prevailing in the molten metal 4. The gas jet 7 has a penetration depth J, which, because of the supersonic speed of the gas, is significantly higher than the penetration depth of gas jets with subsonic speed.

The supersonic nozzle 6, which is used in accordance with the disclosure, can be designed as a Laval supersonic nozzle with a bell-shaped convergent nozzle part 10 and a correspondingly bell-shaped divergent nozzle part 11, wherein the convergent nozzle part 10 merges continuously into the divergent nozzle part 11 in the region of a nozzle throat 12. The largest diameter of the convergent nozzle part 10 determines the inlet cross-section 9 of the supersonic nozzle 6, whereas the largest diameter of the divergent nozzle part 11 determines the outlet cross-section 8 of the supersonic nozzle 6.

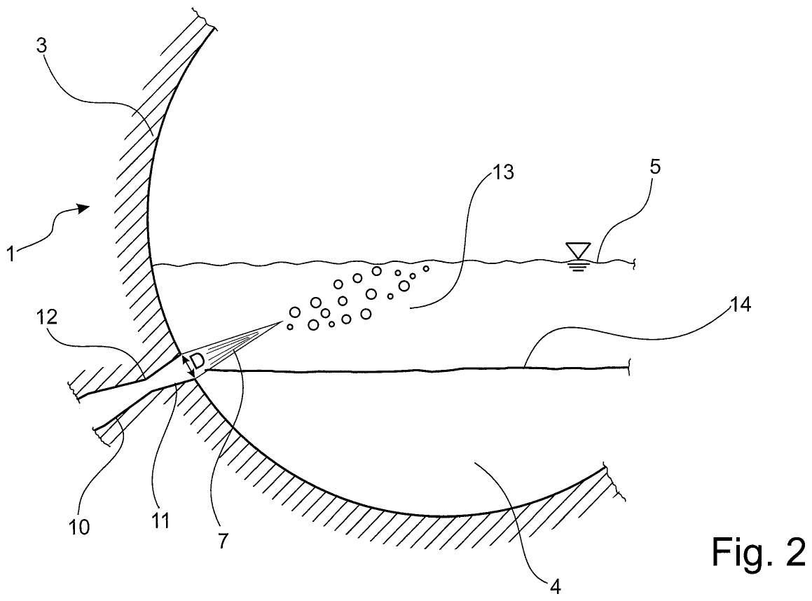

FIG. 2 shows a variant of metallurgical vessel 1 for carrying out the method, which is designed as a Pierce Smith converter. The metallurgical vessel is designed as a cylinder rotatable about the longitudinal axis, the side wall 3 of which is penetrated by at least one supersonic nozzle 6, wherein the supersonic nozzle 6 is arranged in the side wall 3 in such a manner that the gas jet 7 can be introduced into the liquid at supersonic speed either into the liquid phase of the molten metal 4 or into the slag 13 or into the region of a phase boundary 14 between the molten metal 4 and the slag 13 below the surface 5 of the melt bath. With the variant of the metallurgical vessel 1 shown in FIG. 2, the reference signs used in FIG. 1 are used for corresponding features, wherein, in contrast to the metallurgical vessel 1 in accordance with FIG. 1, the side wall does not comprise a distinguished bottom, since the metallurgical vessel comprises a cylindrical shell surface and end faces, wherein the shell surface is designated above as side wall 3.

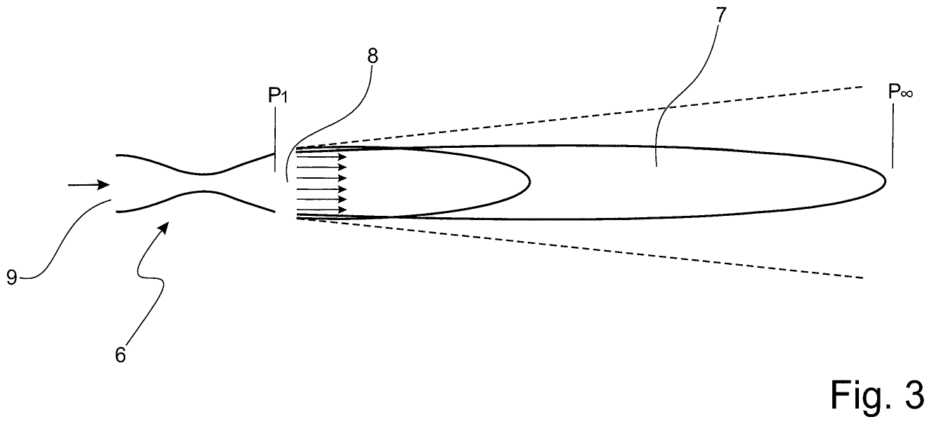

FIGS. 3 to 5 illustrate various modes of operation of the metallurgical plant for treating molten metals.

FIG. 3 shows the speed profile of the gas jet 7 at a supersonic nozzle 6 operated at the design point. With such mode of operation, the pressure p1 at the outlet cross-section 8 of the supersonic nozzle 6 corresponds to the pressure p∞ in the molten metal. The upstream pressure p0 corresponds to the upstream pressure p0 in accordance with the design. A uniform, homogeneous speed profile is established at the outlet cross-section 8 of the supersonic nozzle.

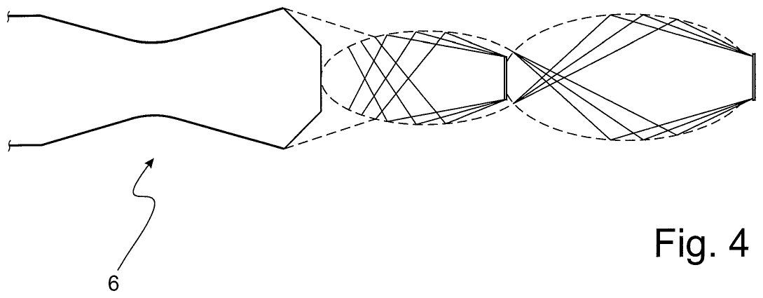

With the variant of operation of the supersonic nozzle 6 illustrated in FIG. 4, the upstream pressure p0 of the process gas is selected to be lower than the upstream pressure p0 in accordance with the design. At the outlet cross-section 8 of the supersonic nozzle 6, there is a correspondingly lower pressure p1 of the process gas, which is lower than the ambient pressure poo in the molten metal 4. As a result, a sequence of compression waves and expansion waves is generated in the molten metal 4, which generates the disturbance pattern shown in the form of compression shocks and expansion waves. The variant of operation of the supersonic nozzle 6 shown in FIG. 3 is referred to as over-expanding mode.

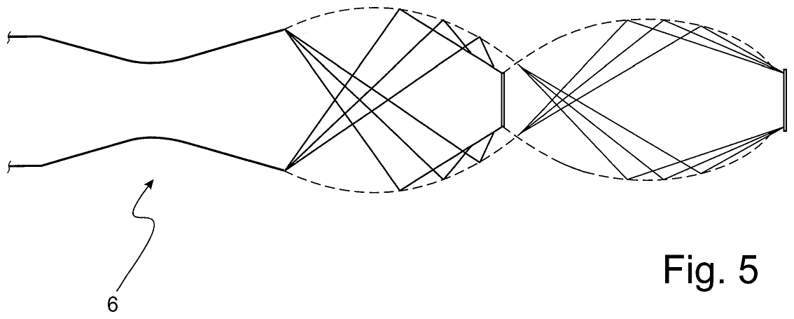

Finally, FIG. 5 shows the disturbance pattern of the gas flow within the molten metal 4 generated at the supersonic nozzle 6 during under-expanding mode. In this mode of operation of the supersonic nozzle 6, the upstream pressure p0 of the process gas is greater than the upstream pressure p0 in accordance with the design. This results in a greater pressure p1 of the process gas at the outlet cross-section 8 of the supersonic nozzle, which is greater than the ambient pressure poo within the molten metal 4. This causes a post-expansion of the process gas within the molten metal 4.

### LIST OF REFERENCE SIGNS

1 Metallurgical vessel
2 Bottom of the metallurgical vessel
3 Side wall of the metallurgical vessel
4 Molten metal
5 Melt bath surface
6 Supersonic nozzle
7 Gas jet
8 Outlet cross-section of the supersonic nozzle
9 Inlet cross-section of the supersonic nozzle
10 Convergent part of the supersonic nozzle
11 Divergent part of the supersonic nozzle
12 Nozzle throat
13 Slag
14 Phase limit
J Penetration depth of the gas jet
p0 Upstream pressure of the process gas
p1 Pressure of the process gas at the outlet cross-section of the supersonic nozzle
p∞ Pressure in the molten metal

1.-12. (canceled)

13. A method for treating molten metals (4) and/or slags in metallurgical baths,
comprising:
introducing a process gas into a melt bath, including accelerating the process gas to supersonic speed and
introducing the process gas below a melt bath surface (5) by at least one supersonic nozzle (6) with supersonic speed into a liquid phase of a molten metal (4) and/or into a slag (13) and/or into a region of a phase boundary (14) between molten metal and slag (13),
wherein the process gas is introduced at several locations of the melt bath using a plurality of supersonic nozzles (6), and
wherein at least one of the plurality of supersonic nozzles (6) is operated outside its gas-dynamic design point.

14. The method according to claim 13,
wherein the process gas is introduced into the molten metal (4) at different heights relative to the melt bath surface (5).

15. The method according to claim 13,
wherein at least one of the plurality of supersonic nozzles (6) comprises a convergent nozzle part (10) and a divergent nozzle part (11).

16. The method according to claim 13,
wherein the gas-dynamic design point of at least one of the plurality of supersonic nozzles (6) is selected such that a gas pressure of the process gas at an outlet cross-section (8) of the supersonic nozzle (6) corresponds to an ambient pressure within the molten metal (4).

17. The method according to claim 13,
wherein at least one of the plurality of supersonic nozzles (6) is subjected to volume flows and/or pressures changes of the process gas during operation.

18. The method according to claim 13,
wherein the process gas is introduced into a metallurgical vessel (1) vertically from below and/or laterally.

19. The method according to claim 13,
comprising using a metallurgical vessel (1) having the plurality of supersonic nozzles (6) passing through a wall and/or a bottom of the metallurgical vessel (1).
